(19) United States
(12) Patent Application Publication
(10) Pub. No.: US 2003/0043047 A1
(43) Pub. Date: Mar. 6, 2003

(54) Electronic doorbell system

(76) Inventor: David A. Braun, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 09/940,616

(22) Filed: Aug. 29, 2001

(51) Int. Cl. G08B 23/00

(52) U.S. Cl. 340/691.1; 340/573.1; 340/692; 340/5.8

(57) ABSTRACT

A doorbell arrangement identifies visitors. The doorbell arrangement includes a user interface that allows a visitor to enter his visitor or user code. The doorbell system is configured to identify visitors by recognizing user codes. The doorbell system generates response signals specific to each visitor. The response signals include audible sounds such as musical tones or voice recordings. The response signals also include radio frequency signals transmitted to remote locations. The doorbell arrangement may include a computer such as a personal computer.

### FIELD OF THE INVENTION

This invention relates generally to a doorbell system and more particularly to an electronic doorbell programmed to automatically identify and respond to visitors or guests.

### BACKGROUND OF THE INVENTION

Doorbells are well known for announcing or signaling the arrival of a visitor at a building, usually a home. However, in general, a doorbell does not recognize the specific identity of a visitor. As a result, a home dweller that may not wish to be disturbed is forced to make her presence known to the visitor. Alternatively, the home dweller may ignore someone that she would not have ignored, had the visitor been identified to her.

Another disadvantage of doorbells occurs if the home dweller is not at home, and she misses visitors and does not know it. This is detrimental if the visitor is someone of importance. There are generally no existing doorbells with means to alert a home dweller in a remote location when there is a visitor.

U.S. Pat. No. 5,365,214 teaches a doorbell system that includes a plurality of stored tones or songs in the doorbell memory. The different songs or tunes are triggered by different events. The opening of a front door, the opening of a back door, or the depression of a particular doorbell button may trigger different songs or tunes. As a result, it is possible to identify the location from which the song or tune is triggered. However it is not possible to recognize the identity of the visitor.

Many present day doorbells are stand-alone devices with a button and an enunciator. Options for the sound that the annunciator makes have been limited, and generally are not customized to a specific guest. U.S. Pat. No. 6,175,298 B1 teaches a doorbell system having a sound memory for storing and playing a CD quality sound. A plurality of musical sounds are stored in the doorbell memory. The storage of the sounds may involve the use of a personal computer. This patent does not disclose how any of the plurality of stored sounds is selected nor does it disclose a stored sound identifying a particular visitor.

Cameras have been used in conjunction with doorbells in order to recognize visitors. U.S. Pat. No. 5,995,139 teaches an interactive system for identifying visitors using a camera and a home computer in conjunction with a doorbell. Image data is captured by the camera, and displayed on a monitor. Although the visitor may be identified this way, the identification is not automatically done by the system. The home dweller recognizes the guest herself from the image displayed. Generally, existing doorbells do not automatically identify visitors.

### SUMMARY OF THE INVENTION

In one respect, the invention is a doorbell arrangement. The doorbell arrangement includes a user interface for entering a user code. The user code is indicative of a specific visitor. The doorbell arrangement also includes a logic circuit for identifying the specific visitor. The identification of the specific visitor is based on the entered user code. The arrangement further includes a signal transmitter for transmitting a particular response signal. The particular response signal is based on the identification of the user by the logic circuit.

In another respect, the invention is a method of identifying a visitor by using a doorbell arrangement. In this respect, the doorbell arrangement has a user interface for entering a user code. The method of identifying a visitor includes the step of receiving the user code. The user code is indicative of the visitor. The method also includes the step of identifying the visitor from the user code. The method of identifying a visitor also includes the step of transmitting a signal in response to the identification of the visitor. The response signal is indicative of the visitor.

In comparison to known prior art, certain embodiments of the invention are capable of achieving certain aspects, including some or all of the following: identifying visitors without the visitor knowing if the home dweller is home or not; automatically responding to visitors; and, notifying a home dweller at a remote location that she has visitors. Furthermore, the system also provides increased home security. Those skilled in the art will appreciate these and other aspects of various embodiments of the invention upon reading the following detailed description of a preferred embodiment with reference to the below-listed drawings.

### BRIEF DESCRIPTION OF THE DRAWINGS

FIG. 1A is a block diagram illustrating an electronic doorbell according to a first exemplary embodiment of the invention;

FIG. 1B is a diagram illustrating an example of a keypad to be used in the invention;

FIG. 2 is a block diagram illustrating an electronic doorbell connected to a computer, according to a second exemplary embodiment of the invention;

FIG. 3 is a flow chart illustrating an exemplary method that may be performed by the doorbell 100 or the doorbell system 222;

FIG. 4A is a chart illustrating examples of keystroke sequences used by different guests; and

FIG. 4B is a chart illustrating examples of audio responses.

### DETAILED DESCRIPTION OF A PREFERRED EMBODIMENT

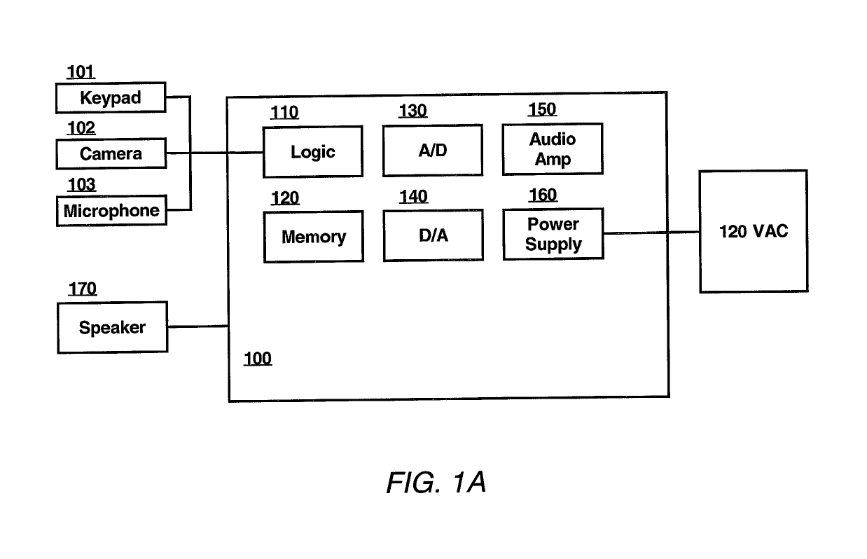

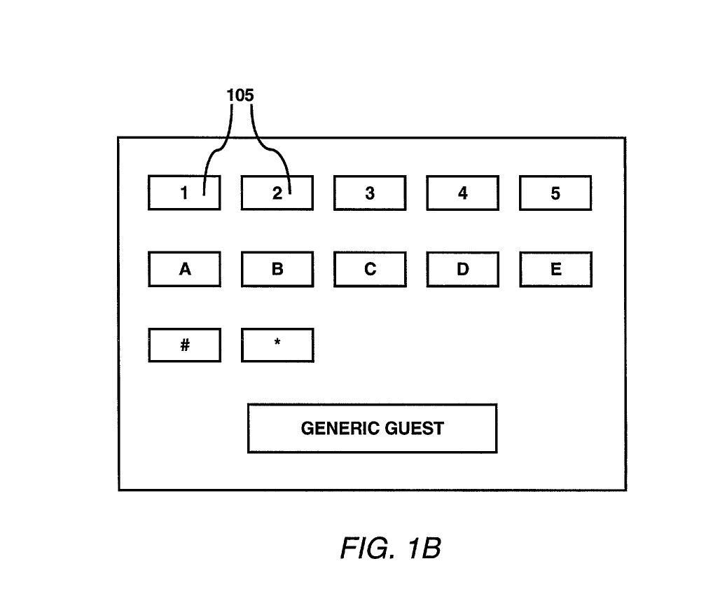

FIG. 1A illustrates an electronic doorbell 100 according to a first exemplary embodiment of the invention. The electronic doorbell 100 may be positioned inside or outside a house, a dorm, or other residence or the like, in conventional manner. Various interface devices may be used in conjunction with the doorbell 100. These devices are used by visitors to enter user codes, and may include a keypad 101, a camera 102, or a microphone 103. The interface devices 101, 102, and 103 may be positioned in the proximity of a doorway, gateway, entryway or the like.

FIG. 1B illustrates an example of a keypad 101 to be used in conjunction with the doorbell 100. The keypad 101 includes alphanumeric keys or buttons 105. In addition, the keys may have distinguishing symbols. The keypad 101 may also contain any reasonable number of keys 105 for purposes of the invention. The keys or buttons may be depressed to enter user codes.

The camera 102 of FIG. 1A may include a CCD (Charge Coupled Device) for capturing a visitor's image and for outputting data according to the brightness of light detected from these images. The camera 102 may also include a scanner for scanning a fingerprint or fingerprint impression. With the camera 102, the user codes are entered as image data.

The microphone 103 includes conventional audio components for capturing sound waves. With the microphone 103, the user codes are entered in the form of audio data. All or one of the interface elements may be included at any particular time.

FIG. 1A also illustrates a doorbell logic circuit 110. The logic circuit 110 is connected to the interface devices for receiving and processing the user codes. The logic circuit 110 processes the user codes in order to identify different visitors. The doorbell 100 also includes a memory module 120. The memory module 120 provides storage area for codes used by the logic circuit 110 in processing user information. The logic circuit 110 compares the stored codes with the user-entered codes. The memory module 120 also stores audio responses that are used in response to the identification of a particular visitor, as will be explained in a subsequent section of the disclosure.

The doorbell 100 also includes an A/D (Analog to Digital) converter 130 and a D/A (Digital to Analog) converter 140. These components are used to convert analog signals into digital information and digital information into analog signals respectively. For instance, the A/D converter may be used to convert from analog to digital format, audio data entered through the microphone 103. The doorbell 100 also includes an audio amplifier 150 for amplifying audio signals. A power supply 160 may be used for providing power to the doorbell 100. The power supply 120 may be a 120VAC. The power supply may also be a battery or any other conventional means of supplying power.

The doorbell 100 also includes a speaker 170, for transmitting audio feedback to a visitor using the doorbell 100. The speaker 170 may be located in the proximity of a doorway, gateway, entryway or the like where a visitor can hear the audio feedback. In addition to the speaker 170, there may also be a plurality of other speakers (not shown) throughout the residence or home, associated with the doorbell 100. These additional speakers allow the home dweller to hear the audio responses.

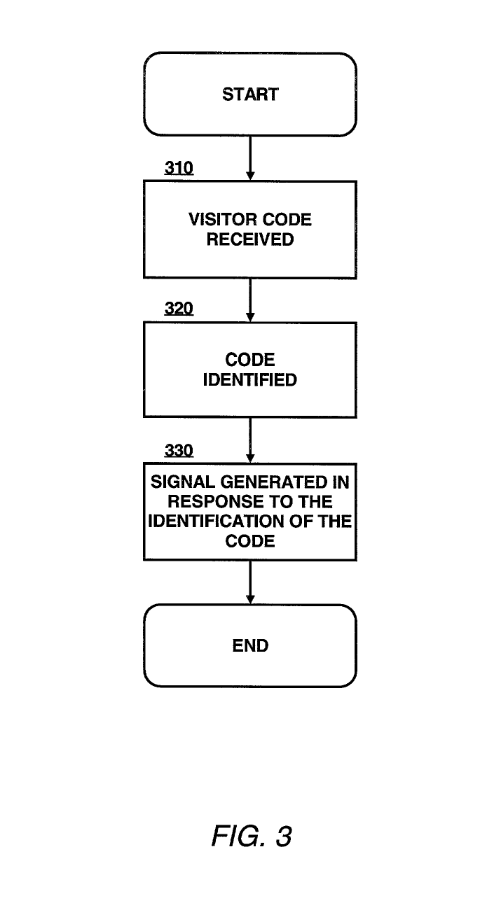

FIG. 3 is a flow chart illustrating an exemplary method of identifying a visitor using the apparatus of FIG. 1A. As illustrated at step 310, a user code from a visitor is received by the doorbell system. A user code may be representative of one visitor or a plurality of visitors. For example, a single user code may represent a home dweller's co-workers. Another code may represent the home dweller's best friend. In step 310, the user code may be entered in a variety of ways, depending on the type of interface device used with the apparatus.

When the keyboard 101 is the interface device, depressing the keys or buttons on the keyboard in a particular keystroke sequence enters the user code. A keystroke sequence may be the depression of a key or a plurality of keys in a predetermined order. For example, a particular visitor may be instructed beforehand by a home dweller to depress specific keys. Another visitor may be instructed by the home dweller to use a different keystroke sequence. The particular sequence is chosen so that the guests can be identified and distinguished, as will be explained in more detail in a subsequent section of this disclosure.

When a camera 102 is used as the interface device, the user code is image data captured by the camera. The image data may include image data (digital or analog) of a user's face, an insignia, a badge, a fingerprint pattern, a barcode, or any other unique recognizable feature that can be captured as an image. The image data may be captured by using conventional means that triggers the camera to capture an image. When a microphone 103 is used as the interface device, the user code is the audio data entered by the user. The audio data may be a user's voice or sequenced clapping pattern or the like.

Returning to FIG. 3, as illustrated, after the user code is received at step 310, the user code is identified at step 320. The logic circuit 110 of FIG. 1A is used to identify the user code that is entered. In identifying a visitor from the user code, the logic circuit 110 relies on stored codes in the memory 120. The logic circuit 110 compares and matches entered user codes with stored codes. When a user code matches a stored code, a visitor is identified. It should be noted that because one user code may be representative of a group of visitors, the circuit 110 may identity a group of possible visitors as opposed to a specific individual.

The identifying step 320 may vary depending on the type of user code. User codes entered using the keypad 101 may be recognized from the keystroke sequence. As described previously, a keystroke sequence may be the depression of a key or a plurality of keys in a predetermined order. Each keystroke sequence is representative of a particular user or a particular group of possible users. The logic circuit 110 compares the user entered keystroke sequence with stored keystroke sequences. When there is a match between the stored keystroke sequence and the user entered keystroke sequence, a visitor is identified. If there is no match, the visitor is not identified.

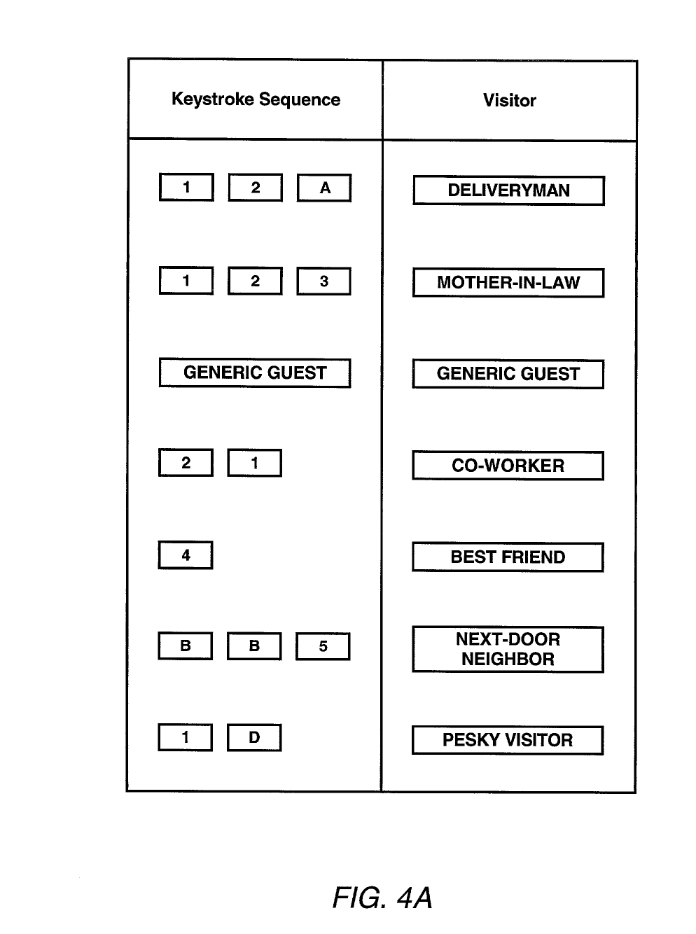

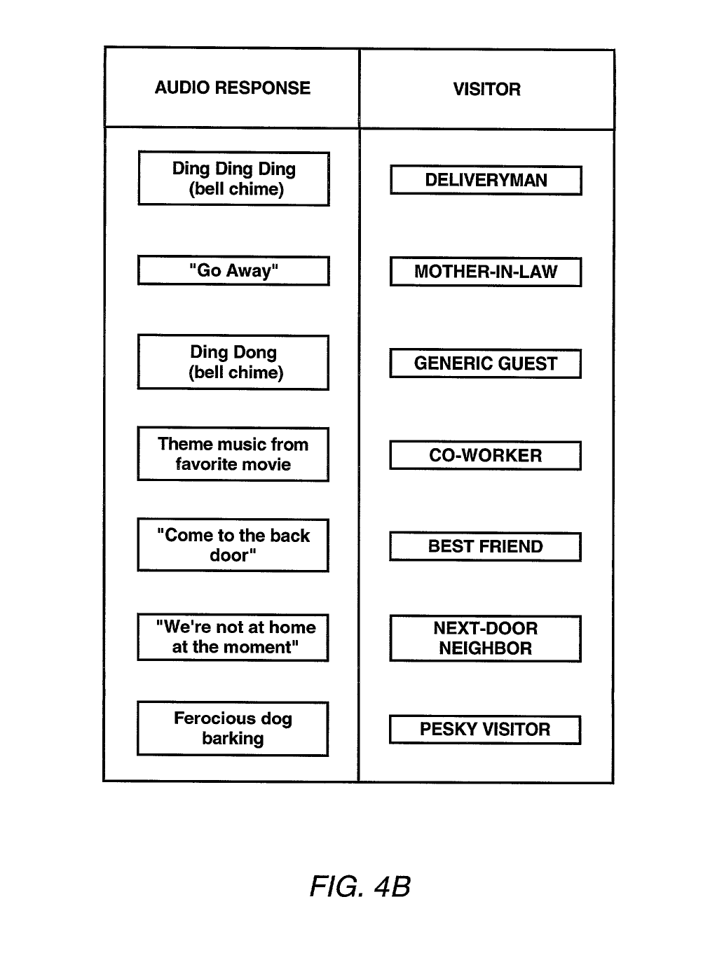

FIG. 4A is a table showing examples of keystroke sequences used by different visitors or guests. As illustrated, the keystroke sequence “1” “2” “A” may be a delivery person's user code, “B” “B” “5” may be a neighbor's user code and keystroke sequence “Generic Guest” may be a user code for generic guests.

Returning to the identifying step 320, when the camera 102 is used as the interface device, the image data captured is the user code. As stated before, the image data may comprise a barcode, a fingerprint, a scanned badge, an insignia, or an image of the visitor's face, etc. The image data is identified using the logic circuit 110. The logic circuit 110 compares the user entered image data sequence with stored image data. When there is a match between the stored image data and the user entered image data, the visitor is identified. If there is no match, the visitor is not identified.

When the microphone 153 is the interface device, the user code is the audio data captured. As stated, the audio data may comprise a voice recording or a sequenced sound such as a clapping sequence. The audio data is identified using the logic circuit 110. The logic circuit 110 compares the user entered audio data with stored audio data. When there is a match between the stored audio data and the user entered audio data, the visitor is identified. If there is no match, the visitor is not identified.

As illustrated in FIG. 3, upon the identification of a user code at step 320, the generation of a response signal takes place at step 330. The response signal may be an audio response signal. The audio response signal enables a home dweller to identify the visitor at the door. The audio responses are made audible to the home dweller through speakers (not shown) placed in any preferred location at the house. The audio response may be made audible to the visitor via transmission through speaker 170.

FIG. 4B is a table showing examples of audio responses based upon the identification of particular visitors or guests. Each audio response is geared towards particular identified visitors. The audio responses may be musical tunes, voice recorded phrases or sentences of any desired language, bell chimes, or the like. As illustrated in the FIG. 4B, the audio response for a generic guest may be a bell chime “Ding Dong.” The response for the next-door neighbor may be the voice recording; “We're not at home at the moment.” The response for a best friend may be the phrase “Come to the back door.” The doorbell memory 120 provides the audio response. There may also be a default audio signal for unrecognized or unidentified guests.

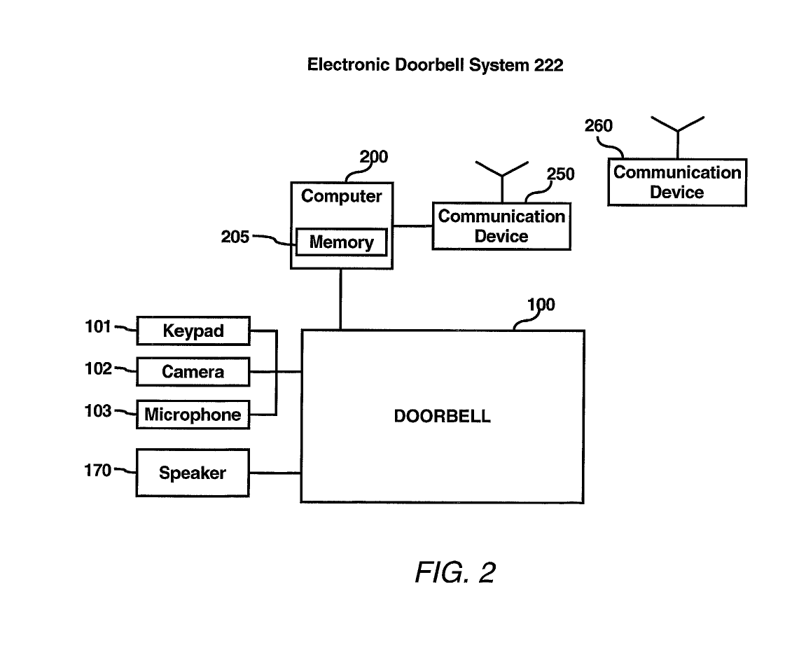

FIG. 2 is a block diagram illustrating an electronic doorbell system 222 with the doorbell 100 interfaced with a computer 200, according to a second exemplary embodiment of the invention. Typically the computer 200 may be a personal computer such as a laptop or a desktop computer. The computer 200 may include a database or memory 205 with stored audio files for providing responses to visitors. The computer 200 may be connected to the doorbell 100 by means of a hardwire connection or the like. The connection may also be wireless such as a Blue Tooth, infrared or radio frequency connection.

FIG. 2 also shows a communication device 250 connected to the computer. The communication device 250 may be a modem, transceiver or the like, and may be used to transmit and receive radio frequency signals. Typically, the computer 200 controls the functions of the communication device 250. A remotely located second communication device 260 is illustrated in FIG. 2. The communication device 260 also transmits and receives radio frequency signals and the communication devices 250 and 260 may communicate with each other. For example, the communication device 250 may send a signal that is received by the communication device 260. In response, the communication device 260 may send a signal to communication device 250. The communication device 260 may be a mobile (digital or cellular) telephone, a pager, or a similar portable device.

FIG. 2 also illustrates various interface devices that may be used in this arrangement, including the keypad 101, the camera 102, and the microphone 103. As with the first exemplary embodiment, one or a plurality of the interface devices may be included in the apparatus of FIG. 2 at any particular time, and the interface devices may be located in the proximity of a doorway, gateway, entryway, or the like. FIG. 2 also illustrates the speaker 170 that may also be located in the proximity of a doorway, gateway, entryway, or the like. The doorbell 100 illustrated in FIG. 2 may also include all the elements illustrated in FIG. 1 including the logic 110, the memory 120, the A/D converter 130, the D/A converter 140, etc.

The method of identifying a visitor using the arrangement illustrated in FIG. 2 may also be outlined by the flow chart illustrated in FIG. 3. Returning to FIG. 3, in step 310, a user code from a visitor is received by the doorbell system 222. As described with respect to the first exemplary embodiment, the user code may be entered using a user interface device. The user code may be entered in a variety of ways, depending on the type of interface device used with the apparatus. The performance of step 310 using the apparatus of the second exemplary embodiment is identical to the performance of step 310 using the apparatus of the first exemplary embodiment. Therefore, the description of step 310 for the first exemplary embodiment is incorporated within for the second exemplary embodiment.

After the user code is received at step 310, the user code is identified at step 320. The logic circuit 110 is used to identify the user code and this identification is based on the user code that is entered. In identifying a visitor from the user code, the logic circuit 110 relies on stored codes in the memory 120. The logic circuit 110 compares and matches entered user codes with stored codes. When a user code matches a stored code, a visitor is identified. The processing here may be similar to the process described with respect to the first exemplary embodiment.

At step 330, the generation of a response signal follows the identification step 320. Based on the recognition or identification of the user code, the doorbell system 222 generates a response signal in step 330. The generation of the response signal according to the second exemplary embodiment is different from the generation of a response signal as described with respect to the first exemplary embodiment. While the signal may be generated from within the doorbell 100 in the first exemplary embodiment, in the second exemplary embodiment the signal is generated by the computer 200.

As stated, and as illustrated in FIG. 2, the doorbell 100 is connected to the computer 200. As a result, communication is facilitated between these two devices. After step 320, i.e., after the identification of the visitor by the logic circuit, the identity of the visitor is transmitted from the doorbell 100 to the computer 200. When the computer 200 is notified of the identity of a visitor, the computer 200 is then able to generate a response signal indicative of the visitor. The speaker 170 transmits the response signal. The response signal may also be transmitted by other speakers (not shown) located throughout the residence.

As in the first exemplary embodiment, another response may be an audio response. The audio responses may be stored in a computer memory 205. Because of the larger memory capacity of the computer 200, more numerous and larger audio files may be stored in the computer memory 205. Also, the quality of the audio responses in the computer memory is better than those stored in a doorbell memory 120. As a result, stored audio responses such as voice recordings are more realistic and comprehensible to a visitor. As outlined above and as illustrated in FIG. 5, each response is geared towards a particular identified visitor and the audio responses are made audible to the home dweller through speakers (not shown) placed in any preferred location at the house. The audio response may be made audible to the visitor via the speaker 170.

Because of the addition of the computer 200, the functions of the doorbell system can be expanded. The computer 200 can be programmed to operate and generate signals according to different modes of operation. For instance, when the computer is operated in a mode in which audio signals are generated in response to visitors initiating the doorbell, as described above, the computer is operating in an “Audio” mode. Also, it is possible to operate in a “Not At Home Audio” mode, which instructs visitors via a voice recording, that home dweller is not at home. Similarly, the computer may be programmed to operate in a “We Are Sleeping/Don't Disturb Audio” mode, which instructs visitors that the occupants of the house are sleeping. There may also be an “Alarm” mode, wherein the audio response may be a vicious dog bark. The dog bark may vary according to the time or the number of times the doorbell is activated within a particular predetermined timeframe. For instance, when the doorbell is first rung, the audio response may be “Woof Woof.” When it is rung a second time the response may be “Rrrr Rrrrrrrr.” Speakers (not shown) within the house may transmit these alarm signals. Operation in this particular “Alarm” mode may provide an increase in home security because of the quality of the barking sounds provided by the computer 200 and also because the barking responses are not repeated within a predetermined timeframe. It should be noted that although the response signals may be similar for all visitors, the system still identifies the visitor by the user code. In addition to the modes described, the system may include a default audio signal for unrecognized or unidentified guests.

Instead of the generation of an audio response and subsequent transmission through the speakers in step 330, the computer 200 may generate radio frequency signals that are transmitted via the communication device 250. Here again, the computer 200 is programmed to operate in a selected “Phone” mode in which radio frequency signals are generated to alert the home dweller that a particular visitor is at the door. The radio frequency signals may be transmitted by the communication device 250 to a remotely located communication device 260. The communication device 260 may be carried by the home dweller. The transmitted signal may include a code that identifies the visitor to the home dweller. The communication device 260 may be a mobile (digital or cellular) telephone, a pager, or a similar portable device. If the communication device 250 is a modem, and the communication device 260 is a mobile telephone, signals may be transmitted between the communication devices 250 and 260, enabling the home dweller to communicate with a visitor. Upon receiving the user code, the modem dials the home dweller's mobile phone. The visitor can speak and hear the home dweller through the microphone 103 and speaker 170.

It should be noted that in the second exemplary embodiment, it is possible to program the computer 200 to vary response types according to user input. In response to some identified visitors the computer may generate audio signals, and in response to other identified guest, the computer 200 may initiate the generation of radio frequency signals. For example, when a neighbor visits and enters a neighbor code, the computer 200 may generate a voice-recorded response; “We are not home at the moment.” However when the home dweller's best friend enters her code in the doorbell system, the computer 200 may call the home dweller's phone (communication device 260). The computer 200 may also provide other services such as logging the identity and times of visit of each visitor that enters a code. The computer 200 may also log the type of signal that was generated in response to the identification of each visitor.

In an alternative method of operation of the arrangement illustrated in FIG. 2, the computer 200 may perform the identification step 320, instead of the logic circuit 110. After a visitor enters the user code, the user code is transferred to the computer 200 as a buffer file. With this information, the computer 200 may identify of the visitor at step 320. The computer would therefore have a file of stored codes, and these stored codes are compared with the entered user codes. When a user code matches one of the stored codes, a visitor is identified. Therefore, the computer performs step 320 in a similar manner as the logic circuit 110. The generation of a response signal may be an audio signal or a radio frequency signal and may be transmitted in a manner previously described.

What has been described and illustrated herein are preferred embodiments of the invention along with some variations. The terms, descriptions and figures used herein are set forth by way of illustration only and are not meant as limitations. For instance, other known user interface devices may be used for the entry of guest information. Keystroke sequences may be entered using a standard doorbell switch and the codes may be entered by short and/or long switch depressions and/or pauses between depressions. Also with respect to the second embodiment wherein the doorbell 100 is combined with the computer 200, all or some of the interface devices may be connected to the doorbell 100 or the computer 200. Those skilled in the art will recognize that many variations are possible within the spirit and scope of the invention, which is intended to be defined by the following claims and their equivalents, in which all terms are meant in their broadest reasonable sense unless otherwise indicated.

What is claimed is:

1. A doorbell arrangement comprising:
a user interface for entering a user code indicative of a specific visitor;
a logic circuit for identifying the specific visitor based on the entered user code; and
a signal transmitter for transmitting a particular response signal wherein the particular response signal is based on the identification of the user by the logic circuit.

2. The arrangement of claim 1 further comprising a memory for storing the response signals to the signal transmitter.

3. The arrangement of claim 1 wherein the user interface is a keypad and the user code is a keystroke sequence.

4. The arrangement of claim 1 wherein the user interface is a camera and the user code is image data captured by the camera.

5. The arrangement of claim 1 wherein the user interface is a microphone and user code is a sound created by the user.

6. The arrangement of claim 2, wherein the signal transmitter is a speaker and the particular response signal is an audio signal.

7. The arrangement of claim 1 further comprising a computer for providing the response signals to the signal transmitter.

8. The arrangement of claim 7, wherein the signal transmitter is a speaker and the particular response signal is an audio signal.

9. The arrangement of claim 8 wherein the signal generator is a first communication device and the particular signal is a radio frequency signal.

10. The arrangement of claim 9 further comprising a second communication device for receiving the radio frequency signal from the first communication device.

11. The arrangement of claim 10 wherein the second communication device is a mobile telephone.

12. The arrangement of claim 6 wherein the user interface is a keypad and the user code is a keystroke sequence.

13. A method of identifying a visitor by using a doorbell arrangement having a user interface for entering a user code, the method comprising:
receiving the user code via the user interface wherein the user code is indicative of the visitor;
automatically identifying the visitor from the user code; and
transmitting a signal in response to the identification of the visitor, wherein the response signal is indicative of the visitor.

14. The method of claim 13 wherein the step of automatically identifying the visitor comprises:
comparing the user code with a plurality of stored codes; and
determining the identity of the visitor from the stored code that matches the user code.

15. The method of claim 14 wherein the user interface is a keypad and the user code is a keystroke sequence entered on the keypad.

16. The method of claim 14 wherein the user interface is a microphone and the user code is a sound created by a user.

17. The method of claim 14 wherein the user interface is a camera, and the user code is image data captured by the camera

18. The method of claim 14 wherein the signal transmitted in response to the user code is an audio signal.

19. The method of claim 18 wherein the audio signal is one of a plurality of alarm signals, wherein the alarm signal transmitted is dependant upon the number of times user codes are entered within a predetermined timeframe.

20. The method of claim 14 wherein the signal transmitted in response to the user code is a radio frequency signal to be received by a communication device at a remote location through which a home dweller and the visitor is able to communicate.
